(19) United States
(12) Patent Application Publication
(10) Pub. No.: US 2018/0124561 A1
(43) Pub. Date: May 3, 2018

(54) Location-Based Number Management

(71) Applicant: Microsoft Technology Licensing, LLC, Redmond, WA (US)

(72) Inventors: Amer Aref Hassan, Kirkland, WA (US); Michael Travis Gilbert, Thornton, CO (US); Bradford R. Clark, Broomfield, CO (US); Richard James Cole, Woodinville, WA (US)

(73) Assignee: Microsoft Technology Licensing, LLC, Redmond, WA (US)

(21) Appl. No.: 15/337,381

(22) Filed: Oct. 28, 2016

(51) Int. Cl. H04W 4/02; H04W 8/26; H04M 3/42

(52) U.S. Cl. CPC H04W 4/021; H04L 61/605; H04M 3/42348; H04W 8/26

(57) ABSTRACT

Techniques for location based number management are described. Generally, a number refers to a set of characters that can be used to initiate communication with a particular resource. In at least some implementations, a number refers to a telephone number that can be dialed to participate in a call between different users. According to various implementations, techniques described herein enable various policies pertaining to the use of telephone numbers at different locations to be enforced. For instance, techniques for location based number management enable a location of a client device to be tracked, and the location to be used for enforcing application location-based policies.

### BACKGROUND

Today's mobile devices provide users with a tremendous amount of portable functionality. For instance, smartphones, tablets, laptops, and so on, enable users to perform a variety of different tasks without being tied to a particular location. The ability to engage in various types of communication in a mobile scenario is particularly useful. A mobile device, for example, typically includes functionality for engaging in different types of communication with other devices and/or services, such as voice calls, video calls, messaging, and so forth. Thus, a user may leverage a mobile device to communicate with other users via a variety of different communication modalities.

While mobile devices enable communication in diverse scenarios, there are challenges to consistently enabling a user to communicate via a particular device when the user moves between geographic locations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for location based number management are described. Generally, a number refers to a set of characters that can be used to initiate communication with a particular resource. In at least some implementations, a number refers to a telephone number that can be dialed to participate in a call between different users. According to various implementations, techniques described herein enable various policies pertaining to the use of telephone numbers at different locations to be enforced. For instance, techniques for location based number management enable a location of a client device to be tracked, and the location to be used for enforcing application location-based policies.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example implementation scenario for validating a current telephone number for a device in accordance with one or more implementations.

FIG. 3 is a flow diagram that describes steps in a method for determining whether a telephone number is valid at a particular location in accordance with one or more implementations.

FIG. 4 is a flow diagram that describes steps in a method for determining locally on a client device whether a telephone number is valid at a particular location in accordance with one or more implementations.

FIG. 5 is a flow diagram that describes steps in a method for determining whether a telephone number is valid at a particular location in accordance with one or more implementations.

FIG. 6 is a flow diagram that describes steps in a method for updating a current telephone number for a client device in accordance with one or more implementations.

FIG. 7 illustrates an example system and computing device as described with reference to FIG. 1, which are configured to implement implementations of techniques described herein.

### DETAILED DESCRIPTION

Techniques for location based number management are described. Generally, a number refers to a set of characters that can be used to initiate communication with a particular resource. In at least some implementations, a number refers to a telephone number that can be dialed to participate in a call between different users.

According to various implementations, techniques described herein enable various policies pertaining to the use of telephone numbers at different locations to be enforced. For instance, a particular regulatory policy may specify that phone numbers with a particular area code are not permitted to be used outside of a defined geographical area. Thus, techniques for location based number management enable a location of a client device to be tracked, and the location to be used for enforcing application location-based policies. In at least some implementations, when a current telephone number being used by a device is determined to be disallowed (“invalid”) at its location, a different telephone number that is valid at the location can be selected for use by the device for making a call.

The use of the term “telephone number” herein is not to be construed as limiting, and it is to be appreciated that “telephone number” may refer to any string of characters, numeric and/or textual, that may be utilized to engage in the exchange of communication media across a network and between different devices. In at least some implementations, a telephone number represents a number that can be used to route a call between an Internet Protocol (IP) network, and a Public Switched Telephone Network (“PSTN”).

In the following discussion, an example environment is first described that is operable to employ techniques described herein. Next, an example scenario is described for location based number management in accordance with one or more implementations. Following this, some example procedures are described in accordance with one or more implementations. Finally, an example system and device are described that are operable to employ techniques discussed herein in accordance with one or more implementations.

Having presented an overview of example implementations in accordance with one or more implementations, consider now an example environment in which example implementations may by employed.

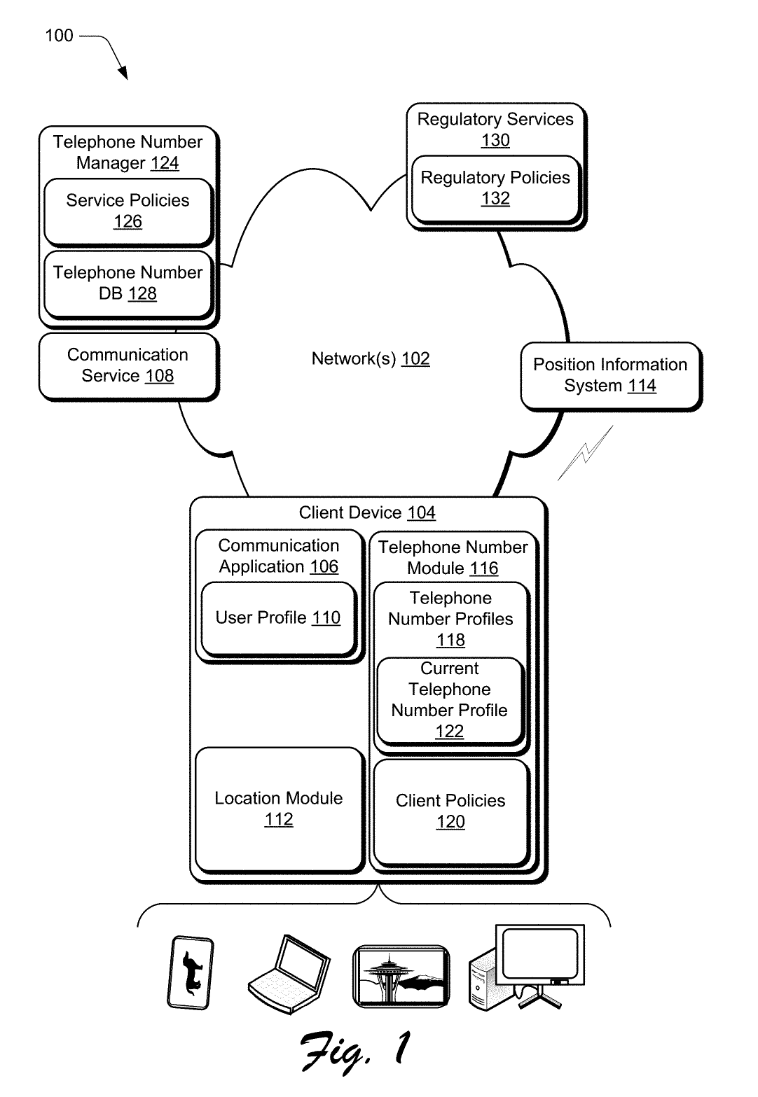

FIG. 1 is an illustration of an environment 100 in an example implementation that is operable to employ techniques for location based number management described herein. The environment 100 includes a communication network 102, which is representative of different connected components that exchange, process, and/or route data to enable different forms of communication. Examples of the network 102 include a local access network (LAN), wide area network (WAN), the Internet, a cellular communication network, an Internet of Things (IoT) network, and combinations thereof. The network 102, for instance, represents a combination of interconnected wireless and wired networks that enable communication at various geographic locations and via a variety of different communication modalities.

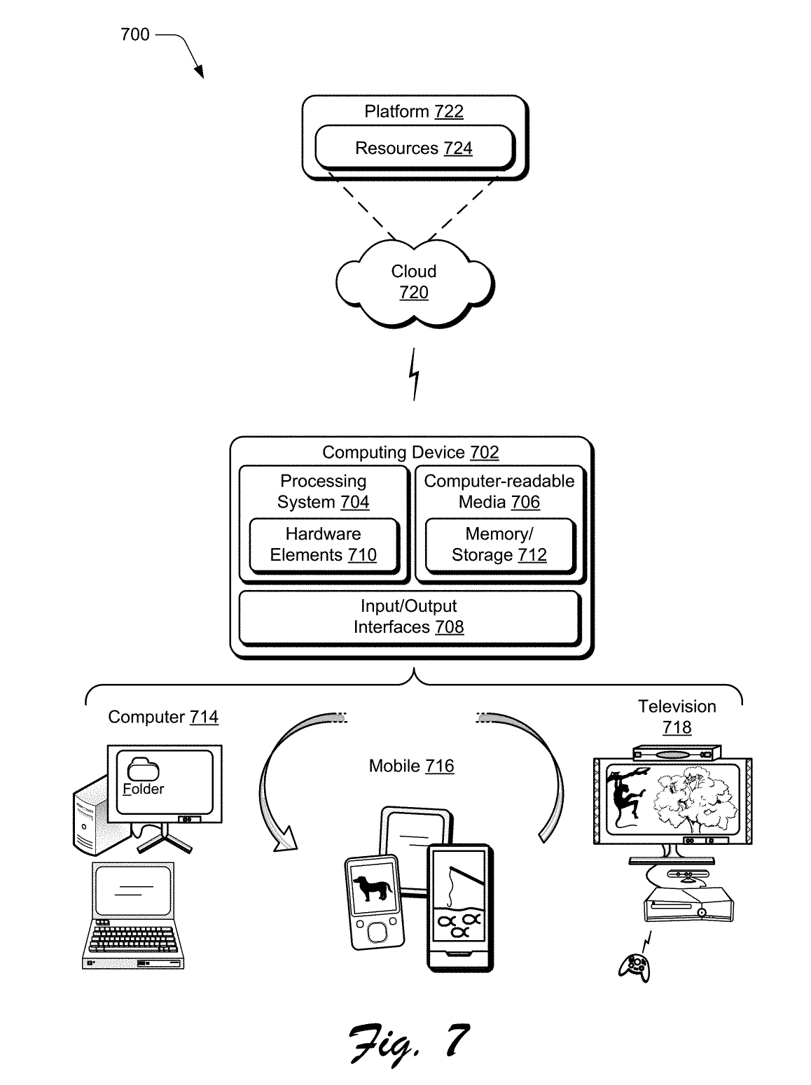

Connected to the network 102 is a client device 104, which is representative of an end-user device configured to communicate via the network 102. The client device 104 may be configured in a variety of ways, such as a wireless cellular phone (e.g., a smartphone), a tablet, a laptop, and so forth. One example implementation of the client device 104 is presented below as the computing device 702 of FIG. 7.

The client device 104 includes a communication application 106, which is representative of functionality to enable different forms of communication via the client device 104. Examples of the communication application 106 include a voice communication application (e.g., a VoIP client), a video communication application, a messaging application, a content sharing application, and combinations thereof. The communication application 106, for instance, enables different communication modalities to be combined to provide diverse communication scenarios. In at least some implementations, the communication application 106 represents an application that is installed on the client device 104. Additionally or alternatively, the communication application 106 can be implemented all or in part as a remote application, such as accessed via a web browser, a web application, and so forth.

According to various implementations, the communication application 106 is configured to enable various types of communication via interaction with a communication service 108. The communication service 108 is representative of a service to perform various tasks for management of communication between the client device 104 and other entities, e.g., other client devices. The communication service 108, for instance, can manage initiation, moderation, and termination of communication sessions for the client device 104. Examples of the communication service 108 include a VoIP service, an online conferencing service, a unified communications and collaboration (UC&C) service, and so forth. In at least some implementations, the communication service 108 may be implemented as and/or be connected to a private branch exchange (PBX) in communication with a Public Switched Telephone Network (“PSTN”) to enable voice communication between the client device 104 and other devices and/or services.

The communication application 106 is associated with a user profile 110, which represents a way of authenticating a particular user with the communication application 106 and the communication service 108, and for tracking user-specific authentication information (e.g., username, password, and so forth), user settings, contacts, and other data for the user. In at least some implementations, the user profile 110 is portable such that the user can authenticate with a different instance of the communication application 106, and make calls via the different instance of the communication application 106 that are identified as being connected with the user profile 110.

The client device 104 further includes a location module 112, which is representative of functionality (e.g., logic and/or hardware) for receiving, transmitting, and/or processing location information. The location module 112, for instance, supports transmission, reception, and processing of position information according to a variety of different technologies, such as Global Positioning System (GPS), cellular communication, WiFi™, satellite communication, radio frequency (RF) communication, subnet information, Ethernet switch and/or port data, Internet Protocol (IP) address information, and so forth.

According to various implementations, the location module 112 can communicate with a position information system 114 to obtain position information for the client device 104. The position information system 114 is representative of various types of position information systems that can transmit and/or receive position information. Examples of the position information system 114 include GPS satellites, cellular telephone networks, wireless data (e.g., WiFi™) networks, location information services (LIS), radio frequency identifier (RFID) functionality, subnets of wired networks, Ethernet switches and/or ports, and so forth.

In at least some implementations, the position information system 114 includes various data network components, such as wired and/or wireless data (e.g., Ethernet) switches, ports, routers, and so forth. The location module 112, for instance, can determine a location of the client device 104 based on an identity of a network and/or network component with which the client device 104 is in communication. Additionally or alternatively, the client device 104 and/or other entity can be notified of a location of the client device 104 as determined by a different resource, e.g., a Location Information Service (LIS) or other location-related service.

According to various implementations, position information can be communicated between the location module 112 and the position information system 114 to enable a location of the client device 104 to be determined. Examples of position information include GPS coordinates, street addresses, network location, location with reference to cell towers and/or cellular base stations, and so forth.

The client device 104 further includes a telephone number module 116, which is representative of functionality for performing various aspects of techniques for location based number management discussed herein. For instance, the telephone number module 116 can determine a particular telephone number that is to be used by the client device 104 for making and/or receiving phone calls at a particular location. Further functionality of the telephone number module 116 is detailed below.

The telephone number module 116 maintains and/or has access to telephone number profiles 118 and client telephone number policies (“client policies”) 120. The telephone number profiles 118 are representative of different telephone numbers that are available to the client device 104 for a phone call. The telephone number profiles 118, for instance, identify different telephone numbers that may be used at different locations for phone calls. Further details concerning the telephone number profiles 118 are presented below.

Further to techniques discussed herein, the telephone number profiles 118 include a current telephone number profile 122, which is representative of a telephone number that is currently identified as selected for the client device 104 for a telephone call. For instance, if a user of the client device 104 dials out a particular telephone number to attempt to connect a call with another device, the connection attempt will show as originating from the current telephone number profile 122. As further detailed below, the current telephone number profile 122 can be selected (e.g., from the telephone number profiles 118) in various ways according to techniques for location based number management described herein.

The client policies 120 represent policies that can be applied to identify which of the telephone number profiles 118 is to be designated as the current telephone number profile 122. For example, when a user of the client device 104 moves between different locations, the client policies 120 can be leveraged to determine which of the telephone number profiles 118 is to be designated as the current telephone number profile 122. The current telephone number profile 122, for instance, may change based on a change in physical location of the client device 104.

In at least some implementations, the telephone number profiles 118 represent telephone numbers that are used by the communication application 106 for making telephone calls. A user, for instance, may interact with the communication application 106 to initiate a VoIP call with another user. The current telephone number profile 122 may be used to identify the client device 104 as the calling device, such as for connecting the call with the called device and for routing call media. Thus, the current telephone number profile 122 and/or others of the telephone number profiles 118 may be used by the communication application 106 at the application layer of the client device 104 to make a call, such as a data call that starts as data from the client device 104, and transitions to call signal at a device connected to a PSTN.

The environment 100 further includes a telephone number manager service (“telephone number manager”) 124, which is representative of a network-based entity for performing various aspects of location based number management described herein. Generally, the telephone number manager 124 represents a remote service that is remote from the client device 104 and that can provide services pertaining to location based number management. The telephone number manager 124 includes service telephone number policies (“service policies”) 126 and a telephone number database (“telephone number DB”) 128. Generally, the service policies 126 represent different policies that can be applied to determine which telephone number a particular device is to use, such as for determining the current telephone number profile 122 for the client device 104.

The telephone number DB 128 represents a database that stores different telephone numbers that can be allocated to different devices, such as the client device 104. For instance, the telephone number DB 128 stores telephone numbers that are valid at different geographic locations, and can allocate the telephone numbers to different users and devices for use at the geographic locations. Thus, in at least some implementations, the telephone number DB 128 represents a pool of phone numbers that accessible to different users and devices to enable the users/devices to obtain valid phone numbers at different locations. For example, based on a current location of the client device 104, the telephone number manager 124 can apply a service policy 126 based on the location to identify a telephone number from the telephone number DB 128 that can be allocated to the client device 104 for making a call. As used herein, “making a call” can refer to dialing out from the client device 104, receiving a call at the client device 104 dialed from a different device, and so forth.

In at least some implementations, the telephone number manager 124 can be implemented and/or managed by a resource such as by the communication service 108, a telephone service and/or system, a cellular network, a data network (e.g., wired and/or wireless), and so forth. Alternatively or additionally, the telephone number manager 124 can be implemented as a standalone service for generating, managing, and/or communicating telephone number policies, telephone numbers, and so forth.

According to one or more implementations, instances of the service policies 126 and/or the client policies 120 can be configured based on information provided by and/or interaction with regulatory services 130. The regulatory services 130, for instance, represent government agencies that generate and apply regulatory policies 132. In at least some implementations, the regulatory services 130 include government agencies that regulate various aspects of communication in different geographical locations. Example functions of the regulatory services 130 include management of wired and/or wireless communication resources, allocation of wireless bandwidth, management of telephone numbering plans (including allocation and management of area codes, dialing codes, and so forth), and so on. As used herein, the term “area code” generally refers to a fixed-length or variable-length set of digits that are used to route calls to communications systems in specific geographic and/or political locations. Examples of an area code include a fixed-length 3 digit code such as used in the United States, Canada, a variable length code such as used in Germany and Japan, and so forth. Generally, an area code is not specific to a particular subscriber, but is used to route a call to a general region.

The regulatory policies 132 are representative of policies that allocate communication resources for different purposes, and that specify various allowed and disallowed communication-related behaviors. In at least some implementations, the regulatory policies 132 define different geographic regions for different telephone numbers, such as area codes that are to be used for specific geographic locations. Further, the regulatory policies 132 may specify that telephone numbers with certain area codes may not be used outside of respective defined locations, such as defined by political boundaries, geographic coordinates, and so forth.

As mentioned above, instances of the service policies 126 can be configured based on interaction with the regulatory services 130. For instance, a particular regulatory policy 132 may specify that a certain area code is not permitted to be used outside of a geographical region defined for the area code. Thus, the telephone number manager 124 can configure a particular service policy 126 to reflect that a telephone number with the area code is not to be used outside of the geographical region. In at least some implementations, the telephone number manager 124 may communicate this service policy 126 to the client device 104 to be used to configure a particular client policy 120. Alternatively or additionally, the telephone number manager 124 may apply the service policy 126 on behalf of the client device 104 to notify the client device 104 that the area code is not permitted to be used outside of the defined geographical area.

Having described an example environment in which the techniques described herein may operate, consider now an example implementation scenario for location based number management in accordance with one or more implementations.

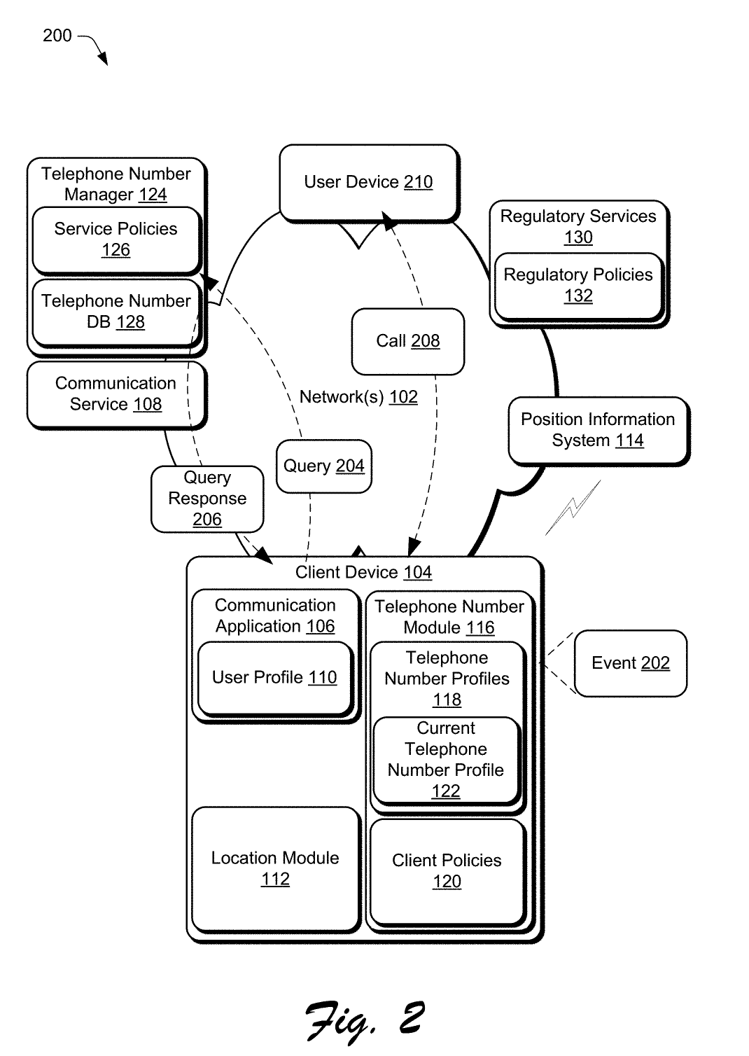

FIG. 2 illustrates an example implementation scenario 200 for validating a current telephone number for a device in accordance with one or more implementations.

In the scenario 200, an event 202 occurs that causes the client device 104 to ascertain whether the current telephone number profile 122 is valid for making a call. In one particular example, the event 202 represents a determination that the client device 104 has moved a threshold distance from a previous location. The telephone number module 116, for instance, receives a notification from the location module 112 of a current location of the client device 104. The telephone number module 116 determines based on the current location that the client device 104 has moved a threshold distance from a previous location. Alternatively or additionally, the client device 104 communicates its current location to the telephone number manager 124, and the telephone number manager 124 determines that the client device 104 has moved a threshold distance from its previous location. A threshold distance may be defined in various ways, such as 500 meters, 1 kilometer, 5 kilometers, and so forth.

As another example, the event 202 represents a periodic location check that occurs at a regular interval, such as every 30 seconds, every minute, and so forth. The periodic check, for instance, causes the client device 104 to perform a location verification procedure to ascertain whether the current telephone number profile 122 is valid, and/or to query the telephone number manager 124 to ascertain whether the current telephone number profile 122 is valid. As yet another example, the event 202 represents a notification of a communication event, such as a user of the client device starting to dial out using the communication application 106, an indication of an incoming call to the client device 104, a calendar notification of an upcoming scheduled call, and so forth.

In still another example, the event 202 represents a user authentication with the communication application 106 via the user profile 110. For instance, a user enters authentication information for the communication application 106, which causes the user to be authenticated with the communication application 106 via the user profile 110. Thus, various settings and user data associated with the user profile 110 can be applied to the communication application 106. In at least some implementations, the user profile 110 is associated with a pre-assigned telephone number for making calls via the communication application 106, such that was assigned when the user created the user profile 110. Accordingly, in response to the user authentication with the communication application 106, the pre-assigned telephone number can be designated as the current telephone number profile 122.

Further to the scenario 200, and in response to the event 202, the current telephone number profile 122 can be checked against the current location of the client device 104. For instance, the telephone number module 116 can compare the current telephone number profile 122 (e.g., its area code) and the current location of the client device 104 to the client policies 120 to ascertain whether the current telephone number profile 122 is valid at the current location. If the client policies 120 indicate that the current telephone number profile 122 is valid at the current location, the client device 104 (e.g., the communication application 106) may proceed with using the current telephone number profile 122 for making a call. However, if the client policies 120 indicate that the current telephone number profile 122 is not valid at the current location (e.g., not allowed due to a regulatory policy 132), the telephone number module 116 may block use of the current telephone number profile 122 at the current location, and/or may initiate a process for updating the current telephone number profile 122 with a telephone number that is valid at the current location.

Alternatively or additionally to a local policy check of the client policies 120, the client device 104 communicates a query 204 to the telephone number manager 124. Generally, the query 204 identifies a current location of the client device 104. Accordingly, the telephone number manager 124 compares the current location of the client device 104 to the service policies 126 to identify a service policy that applies at the location. The telephone number manager 124 returns a query response 206 to the client device 104 based on the identified service policy.

The query response 206, for instance, may include various information. For example, the query response 206 can include the identified service policy 126 such that the client device 104 can receive the service policy and apply it locally, such as to configure the client policies 120 and to ascertain whether the current telephone number profile 122 is valid at its current location.

In one or more implementations, the query 204 can identify a current location of the client device 104 as well as the current telephone number profile 122. Thus, the telephone number manager 124 can compare the current location and the current telephone number profile 122 to the service policies 126 to ascertain whether the current telephone number profile 122 is valid at its current location. If the current telephone number profile 122 is valid, the query response 206 can indicate that the current telephone number profile 122 is valid at the current location. However, if the telephone number manager 124 determines that the current telephone number profile 122 is not valid at the current location, the query response 206 can indicate that the current telephone number profile 122 is not valid.

In one or more implementations, the query response 206 can include a valid telephone number that is valid at the current location, such as selected from the telephone number DB 128. The telephone number DB 128, for instance, maintains a list of telephone numbers that are valid at different locations, such as based on parameters specified by the service policies 126. Thus, the telephone number module 116 can update the current telephone number profile 122 with a valid telephone number as specified by the query response 206.

Thus, the scenario 200 demonstrates that validation of the current telephone number profile 122 can occur locally at the client device 104 and/or via interaction between the client device 104 and the telephone number manager 124. Further, policy decisions as to the validity of the current telephone number profile 122 can be made locally at the client device 104 or remotely by the telephone number manager 124. In the latter case, the results of such policy decisions can be communicated from the telephone number manager 124 to the client device 104.

According to various implementations, the client device 104 ascertains that the current telephone number profile 122 is valid at its current location, or updates the current telephone number profile 122 with a telephone number that is valid at the current location. Accordingly, the client device 104 utilizes the current telephone number profile 122 from the current location to make a call 208 with a user device 210. The call 210, for instance, represents an exchange of call media between the communication application 106 and the user device 210. In at least some implementations, the user device 210 represents a telephone connected to a PSTN, and thus the call 208 can transition between an IP call at the client device 104 side, to a PSTN call with the user device 210.

Having discussed some example implementation scenarios, consider now a discussion of some example procedures in accordance with one or more implementations.

The following discussion describes some example procedures for location based number management in accordance with one or more implementations. The example procedures may be employed in the environment 100 of FIG. 1, the system 700 of FIG. 7, and/or any other suitable environment. The procedures, for instance, represent example ways of performing various aspects of the scenario described above. In at least some implementations, the steps described for the various procedures can be implemented automatically and independent of user interaction. Further, various steps of the procedures may be performed by a client, such as the client device 104. Additionally or alternatively, steps may be performed on a network side, such as by the telephone number manager 124 and/or the communication service 108.

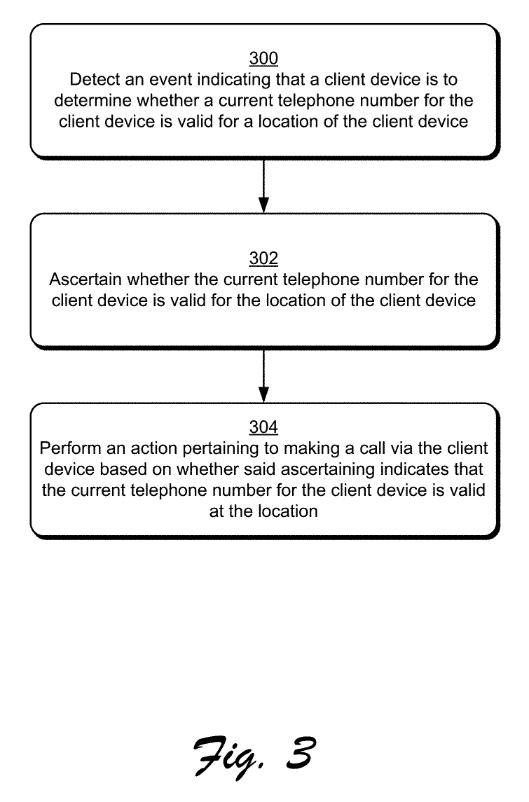

FIG. 3 is a flow diagram that describes steps in a method in accordance with one or more implementations. In at least some implementations, the method describes an example way of determining whether a telephone number is valid at a particular location.

Step 300 detects an event indicating that a client device is to determine whether a current telephone number for the client device is valid for a location of the client device. Examples of such an event are described above, such as a determination that the client device has moved a threshold distance from a previous location, a user authentication with the communication application 106, a periodic check for whether a current telephone number is valid at a current location, the occurrence of a communication event (e.g., an outgoing call from the client device, an incoming call to the client device, and so forth), and so on.

Step 302 ascertains whether the current telephone number for the client device is valid for the location of the client device. Ascertaining whether a current telephone number is valid at a location can be performed in various ways. The telephone number module 116, for instance, can perform a verification procedure locally on the client device 104 to determine whether a telephone number is valid. Alternatively or additionally, the client device 104 can query the telephone number manager 124 with its location and/or the current telephone number profile 122 to determine whether the current telephone number profile 122 is valid at its current location.

Step 304 performs an action pertaining to making a call via the client device based on whether said ascertaining indicates that the current telephone number for the client device is valid at the location. For instance, if the current telephone number profile 122 is determined to be valid, the client device 104 can use the current telephone number profile 122 for making a call. A user, for instance, can use the client device 104 dial a call and connect to a different device using the current telephone number profile 122. The devices can then exchange call media as part of the call.

However, if the current telephone number profile 122 is determined to not be valid at the current location, the action can take various other forms, such as blocking the client device 104 from using the current telephone number at the location, updating the current telephone number with a different telephone number, querying the telephone number manager 124 for a telephone number that is valid at the location, and so forth. In a case where the invalid current telephone number is able to be updated, for example, the updated telephone number can be used by the client device 104 to make a call.

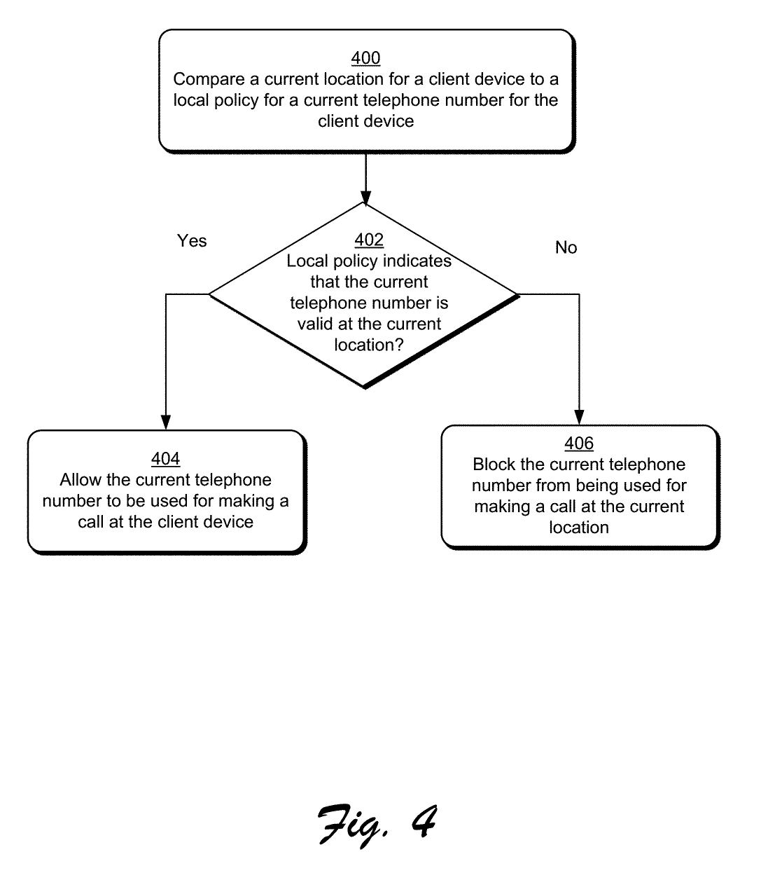

FIG. 4 is a flow diagram that describes steps in a method in accordance with one or more implementations. In at least some implementations, the method describes an example way of determining locally on a client device whether a telephone number is valid at a particular location. The method, for instance, represents an example way for performing aspects of the procedure described above with reference to FIG. 3.

Step 400 compares a current location for a client device to a local policy for a current telephone number for the client device. The telephone number module 116, for instance, compares a current location of the client device 104 to a client policy 120 that applies for the current location and/or the current telephone number profile 122.

Step 402 ascertains whether the local policy indicates that the current telephone number is valid at the current location. The client policies 120, for instance, specify permissions for different area codes, such as whether phone numbers with particular area codes are permitted to be used at particular locations and/or whether phone numbers with particular area codes are permitted to be used outside of particular locations. For example, a particular client policy 120 may specify that a particular area code is not permitted to be used to make a call outside of a particular geographical region, such as a city, a province, a country, and so forth.

If the local policy indicates that the current telephone number is valid at the current location (“Yes”), step 404 allows the current telephone number to be used for making a call at the client device. The telephone number module 116, for instance, allows the communication application 106 to use the current telephone number profile 122 for making a call.

If the local policy indicates that the current telephone number is not valid at the current location (“No”), step 406 blocks the current telephone number from being used for making a call at the current location. For example, the telephone number module 116 prevents the current telephone number profile 122 from being used by the communication application 106 for making a call at the current location. In at least some implementations, when the current telephone number profile 122 is determined to be invalid at a current location, a process for locating a valid telephone number can be initiated, such as described elsewhere in this disclosure.

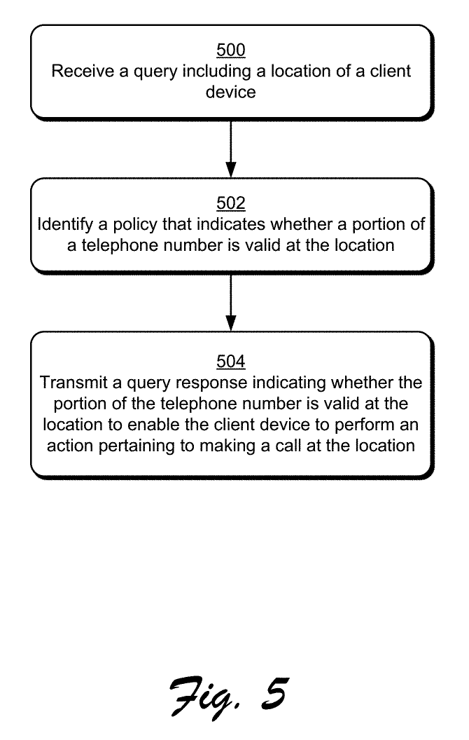

FIG. 5 is a flow diagram that describes steps in a method in accordance with one or more implementations. In at least some implementations, the method describes an example way of determining whether a telephone number is valid at a particular location.

Step 500 receives a query including a location of a client device. The telephone number manager 124, for example, receives a query that includes a location of the client device 104. The query may include other information as well, such as the current telephone number profile 122. In one or more implementations, the query may include only an area code portion of the current telephone number profile 122, without other portions of a phone number associated with the current telephone number profile 122. Alternatively, the query may include an entire phone number from the current telephone number profile 122.

Step 502 identifies a policy that indicates whether a portion of a telephone number is valid at the location. For instance, the telephone number manager 124 searches the service policies 126 to identify a policy that applies to the location. The policy, for example, may specify particular area codes that are permitted to be used at the location, and/or area codes that are not permitted to be used at the location.

Alternatively or additionally, when the query includes a telephone number such as the current telephone number profile 122, the telephone number manager 124 can locate a service policy that applies to the telephone number. For example, the telephone number manager 124 can identify an area code portion of the current telephone number profile 122, and can locate a service policy 126 that applies to the area code.

Step 504 transmits a query response indicating whether the portion of the telephone number is valid at the location to enable the client device to perform an action pertaining to making a call at the location. In one or more implementations, the telephone number manager 124 can transmit a located service policy 126 as part of the query response. The telephone number manager 124, for instance, can transmit the service policy 126 without a separate indication as to whether the current telephone number profile 122 is valid at the particular location. Alternatively or additionally, the telephone number manager 124 can apply the located service policy 126 to ascertain whether a telephone number received with the query is valid at the particular location, and can explicitly specify in the query response whether the phone number is valid at the location.

Based on the query response, the client device 104 can perform various actions, examples of which described above.

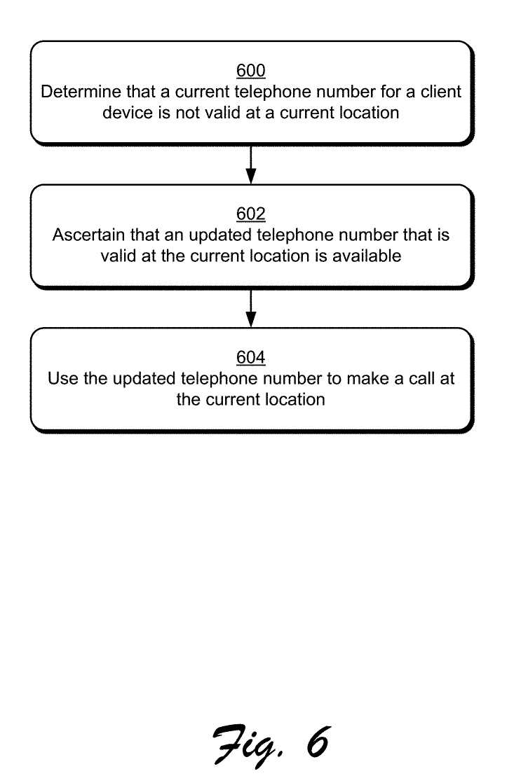

FIG. 6 is a flow diagram that describes steps in a method in accordance with one or more implementations. In at least some implementations, the method describes an example way of updating a current telephone number for a client device.

Step 600 determines that a current telephone number for a client device is not valid at a current location. This may be performed in various ways, such as locally on the client device 104, remotely at the telephone number manager 124, via interaction between the client device 104 and the telephone number manager 124, and so forth. Example ways of determining whether a telephone number is valid at a location are discussed above.

Step 602 ascertains that an updated telephone number that is valid at the current location is available. The telephone number module 116, for example, searches the telephone number profiles 118 and locates a telephone number that is valid at the current location. The telephone number profiles 118, for instance, may be indexed based on location such that they can be searched with a location value to identify a valid telephone number at the location.

Alternatively or additionally, the client device 104 can query the telephone number manager 124 with its current location (such as described above), and the telephone number manager 124 can search the telephone number DB 128 for a telephone number that is valid at the location. The telephone number manager 124 then returns the valid telephone number to the client device 104.

Step 604 uses the updated telephone number to make a call at the current location. The telephone number module 116, for example, replaces the current telephone number profile 122 with the updated telephone number. Thus, the client device 104 (e.g., the communication application 106) can utilize the updated telephone number to initiate an outgoing call, receive an incoming call, and so forth.

In one or more implementations, this procedure may determine that the current telephone number is not valid for making an outgoing call from the client device 104, but is valid for receiving an incoming call at the client device from a different device, or vice-versa. In such case, the current telephone number can be used for one of making an outgoing call from the client device 104 or receiving an incoming call, and the updated telephone number can be used for the other of making an outgoing call from the client device or receiving an incoming call at the client device from a different device. The telephone number module 116, for instance, may configure the current telephone number profile 122 to include a telephone number for routing outgoing calls, and a different telephone number for routing incoming calls.

According to one or more implementations, a telephone number provided by the telephone number manager 124 to the client device 104 can be allocated for temporary use by the client device 104. For instance, permission for the client device 104 to use an allocated telephone number can expire after a certain time period elapses after communicating the telephone number to the client device 104. Examples of such a time period include 1 hour, 12 hours, 1 day, and so forth. Alternatively or additionally, an allocated telephone number can be single use such that after the client device 104 uses the telephone number to make a call, permission for the client device 104 to use the telephone number expires. In at least some implementations, after permission to use an allocated telephone number expires, the telephone number is marked in the telephone number DB 128 as available for allocation to other devices.

Thus, techniques for location based number management described herein enable devices to roam between different locations and engage in telephonic communication at the locations, which maintaining compliance with various policies that govern telephony at the different locations.

Having discussed some example procedures, consider now a discussion of an example system and device in accordance with one or more implementations.

FIG. 7 illustrates an example system generally at 700 that includes an example computing device 702 that is representative of one or more computing systems and/or devices that may implement various techniques described herein. For example, the client device 104 discussed above with reference to FIG. 1 can be embodied as the computing device 702. The computing device 702 may be, for example, a server of a service provider, a device associated with the client (e.g., a client device), an on-chip system, and/or any other suitable computing device or computing system.

The example computing device 702 as illustrated includes a processing system 704, one or more computer-readable media 706, and one or more Input/Output (I/O) Interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 710 and computer-readable media 706 are representative of instructions, modules, programmable device logic and/or fixed device logic implemented in a hardware form that may be employed in some implementations to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of modules that are executable by the computing device 702 as software may be achieved at least partially in hardware, e.g., through use of computer-readable storage media and/or hardware elements 710 of the processing system. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one implementation, the central computing device may be a cloud of one or more server computers that are connected to the multiple devices through a network, the Internet, or other data communication link.

In one implementation, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one implementation, a class of target devices is created and experiences are tailored to the generic class of devices. A class of devices may be defined by physical features, types of usage, or other common characteristics of the devices.

In various implementations, the computing device 702 may assume a variety of different configurations, such as for computer 714, mobile 716, and television 718 uses. Each of these configurations includes devices that may have generally different constructs and capabilities, and thus the computing device 702 may be configured according to one or more of the different device classes. For instance, the computing device 702 may be implemented as the computer 714 class of a device that includes a personal computer, desktop computer, a multi-screen computer, laptop computer, netbook, and so on.

The computing device 702 may also be implemented as the mobile 716 class of device that includes mobile devices, such as a mobile phone, portable music player, portable gaming device, a tablet computer, a multi-screen computer, and so on. The computing device 702 may also be implemented as the television 718 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. For example, functionalities discussed with reference to the telephone number module 116 and/or the telephone number manager 124 may be implemented all or in part through use of a distributed system, such as over a “cloud” 720 via a platform 722 as described below.

The cloud 720 includes and/or is representative of a platform 722 for resources 724. The platform 722 abstracts underlying functionality of hardware (e.g., servers) and software resources of the cloud 720. The resources 724 may include applications and/or data that can be utilized while computer processing is executed on servers that are remote from the computing device 702. Resources 724 can also include services provided over the Internet and/or through a subscriber network, such as a cellular or Wi-Fi network.

The platform 722 may abstract resources and functions to connect the computing device 702 with other computing devices. The platform 722 may also serve to abstract scaling of resources to provide a corresponding level of scale to encountered demand for the resources 724 that are implemented via the platform 722. Accordingly, in an interconnected device implementation, implementation of functionality described herein may be distributed throughout the system 700. For example, the functionality may be implemented in part on the computing device 702 as well as via the platform 722 that abstracts the functionality of the cloud 720.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A system for ascertaining whether a telephone number for making a call via a client device is valid at a location, the system comprising: at least one processor; and one or more computer-readable storage media including instructions stored thereon that, responsive to execution by the at least one processor, cause the system perform operations including: detecting an event indicating that a client device is to determine whether a current telephone number for the client device is valid for a location of the client device; ascertaining whether the current telephone number for the client device is valid for the location of the client device, said ascertaining including at least one of: performing a verification procedure locally on the client device to determine whether the current telephone number complies with a client policy for the location of the client device; or communicating a query that includes the location of the client device to a remote service, and receiving a query response that indicates whether the current telephone number is valid at the location; and performing an action pertaining to making a call via the client device based on whether said ascertaining indicates that the current telephone number for the client device is valid at the location.

In addition to any of the above described systems, any one or combination of: wherein the event comprises an indication that the location of the client device moves a threshold distance from a previous location of the client device; wherein the event comprises a periodic check to ascertain whether the current telephone number is valid for the location of the client device, wherein the event comprises one or more of an indication of an action to initiate a call from the client device, or an indication of an incoming call to the client device, wherein said ascertaining whether the current telephone number for the client device is valid for the location of the client device is based at least in part on a regulatory policy that applies for one or more of the current telephone number or the location of the client device, wherein said ascertaining comprises performing the verification procedure locally on the client device, and the verification procedure comprises comparing the current telephone number and the location of the client device to a client policy that indicates whether the current telephone number is valid at the location of the client device, wherein: said ascertaining comprises performing the verification procedure locally on the client device; the verification procedure comprises comparing the current telephone number and the location of the client device to a client policy that indicates that the current telephone number is not valid at the location of the client device; and said performing the action pertaining to making the call via the client device comprises one or more of blocking the client device from using the current telephone number to make a call at the location of the client device, or updating the current telephone number with a different telephone number that is valid at the location of the client device, wherein: said ascertaining comprises communicating the query that includes the location of the client device to the remote service; the query response indicating that the current telephone number is not valid at the current location; and said performing the action pertaining to making the call via the client device comprises one or more of blocking the client device from using the current telephone number to make a call at the location of the client device, or updating the current telephone number with a different telephone number that is valid at the location of the client device, wherein: said ascertaining comprises communicating the query that includes the location of the client device to the remote service; the query response indicating that the current telephone number is not valid at the current location and including a different telephone number that is valid at the current location; and said performing the action pertaining to making the call via the client device comprises updating the current telephone number with the different telephone number that is valid at the location of the client device, wherein said ascertaining whether the current telephone number is valid and said performing an action pertaining to making the call are performed on behalf of a communication application to which the current telephone number is assigned, wherein: said ascertaining indicates that the current telephone number is not valid for one of but is valid for the other of: making an outgoing call from the client device, or receiving an incoming call at the client device from a different device; and said performing the action comprises using a different telephone number for the other of making an outgoing call from the client device, or receiving an incoming call at the client device from a different device.

A computer-implemented method for ascertaining whether a telephone number for making a call via a client device is valid at a location, the method comprising: detecting an event indicating that a client device is to determine whether a current telephone number for the client device is valid for a location of the client device; ascertaining whether the current telephone number for the client device is valid for the location of the client device, said ascertaining including communicating a query that includes the location of the client device to a remote service, and receiving a query response that indicates whether the current telephone number is valid at the location; and performing an action pertaining to making a call via the client device based on whether the query response indicates that the current telephone number for the client device is valid at the location.

In addition to any of the above described methods, any one or combination of: wherein the query further includes the current telephone number, the query response includes an indication that the current telephone number is not valid at the location, and said performing an action comprises blocking the client device from using the current telephone number for making a call at the location, wherein the query response indicates that the current telephone number is not valid at the location and includes a different telephone number that is valid at the location, and wherein said performing an action comprises: using the different telephone number to update the current telephone number; and using the updated current telephone number to place a call via the client device.

A computer-implemented method for ascertaining whether a telephone number for making a call via a client device is valid at a location, the method comprising: receiving a query including a location of a client device; identifying, by a computing system, a policy that indicates whether a portion of a telephone number is valid at the location; and transmitting, from the computing system for receipt by the client device, a query response indicating whether the portion of the telephone number is valid at the location to enable the client device to perform an action pertaining to making a call at the location.

In addition to any of the above described methods, any one or combination of: wherein the portion of the telephone number includes an area code without other portions of a telephone number, wherein the query further includes the portion of the telephone number, wherein the query response comprises the policy, wherein the policy indicates that the portion of the telephone number is not valid at the location, and the query response indicates that the portion of the telephone number is not valid at the location, wherein: the policy indicates that the portion of the telephone number is not valid at the location; the method further comprises locating, by the computing system, a telephone number that is valid at the location; and the query response indicates that the portion of the telephone number is not valid at the location and includes a telephone number that is valid at the location.

Techniques for location based number management are described. Although implementations are described in language specific to structural features and/or methodological acts, it is to be understood that the implementations defined in the appended claims are not necessarily limited to the specific features or acts described. Rather, the specific features and acts are disclosed as example forms of implementing the claimed implementations.

What is claimed is:

1. A system comprising:
at least one processor; and
one or more computer-readable storage media including instructions stored thereon that, responsive to execution by the at least one processor, cause the system perform operations including:
detecting an event indicating that a client device is to determine whether a current telephone number for the client device is valid for a location of the client device;
ascertaining whether the current telephone number for the client device is valid for the location of the client device, said ascertaining including at least one of:
performing a verification procedure locally on the client device to determine whether the current telephone number complies with a client policy for the location of the client device; or
communicating a query that includes the location of the client device to a remote service, and receiving a query response that indicates whether the current telephone number is valid at the location; and
performing an action pertaining to making a call via the client device based on whether said ascertaining indicates that the current telephone number for the client device is valid at the location.

2. A system as recited in claim 1, wherein the event comprises an indication that the location of the client device moves a threshold distance from a previous location of the client device.

3. A system as recited in claim 1, wherein the event comprises a periodic check to ascertain whether the current telephone number is valid for the location of the client device.

4. A system as recited in claim 1, wherein the event comprises one or more of an indication of an action to initiate a call from the client device, or an indication of an incoming call to the client device.

5. A system as recited in claim 1, wherein said ascertaining whether the current telephone number for the client device is valid for the location of the client device is based at least in part on a regulatory policy that applies for one or more of the current telephone number or the location of the client device.

6. A system as recited in claim 1, wherein said ascertaining comprises performing the verification procedure locally on the client device, and the verification procedure comprises comparing the current telephone number and the location of the client device to a client policy that indicates whether the current telephone number is valid at the location of the client device.

7. A system as recited in claim 1, wherein:
said ascertaining comprises performing the verification procedure locally on the client device;
the verification procedure comprises comparing the current telephone number and the location of the client device to a client policy that indicates that the current telephone number is not valid at the location of the client device; and
said performing the action pertaining to making the call via the client device comprises one or more of blocking the client device from using the current telephone number to make a call at the location of the client device, or updating the current telephone number with a different telephone number that is valid at the location of the client device.

8. A system as recited in claim 1, wherein:
said ascertaining comprises communicating the query that includes the location of the client device to the remote service;
the query response indicating that the current telephone number is not valid at the current location; and
said performing the action pertaining to making the call via the client device comprises one or more of blocking the client device from using the current telephone number to make a call at the location of the client device, or updating the current telephone number with a different telephone number that is valid at the location of the client device.

9. A system as recited in claim 1, wherein:
said ascertaining comprises communicating the query that includes the location of the client device to the remote service;
the query response indicating that the current telephone number is not valid at the current location and including a different telephone number that is valid at the current location; and
said performing the action pertaining to making the call via the client device comprises updating the current telephone number with the different telephone number that is valid at the location of the client device.

10. A system as recited in claim 1, wherein said ascertaining whether the current telephone number is valid and said performing an action pertaining to making the call are performed on behalf of a communication application to which the current telephone number is assigned.

11. A system as recited in claim 1, wherein:
said ascertaining indicates that the current telephone number is not valid for one of but is valid for the other of: making an outgoing call from the client device, or receiving an incoming call at the client device from a different device; and
said performing the action comprises using a different telephone number for the other of making an outgoing call from the client device, or receiving an incoming call at the client device from a different device.

12. A computer-implemented method, comprising:
detecting an event indicating that a client device is to determine whether a current telephone number for the client device is valid for a location of the client device;
ascertaining whether the current telephone number for the client device is valid for the location of the client device, said ascertaining including communicating a query that includes the location of the client device to a remote service, and receiving a query response that indicates whether the current telephone number is valid at the location; and
performing an action pertaining to making a call via the client device based on whether the query response indicates that the current telephone number for the client device is valid at the location.

13. A method as described in claim 12, wherein the query further includes the current telephone number, the query response includes an indication that the current telephone number is not valid at the location, and said performing an action comprises blocking the client device from using the current telephone number for making a call at the location.

14. A method as described in claim 12, wherein the query response indicates that the current telephone number is not valid at the location and includes a different telephone number that is valid at the location, and wherein said performing an action comprises:
using the different telephone number to update the current telephone number; and
using the updated current telephone number to place a call via the client device.

15. A computer-implemented method, comprising:
receiving a query including a location of a client device;
identifying, by a computing system, a policy that indicates whether a portion of a telephone number is valid at the location; and
transmitting, from the computing system for receipt by the client device, a query response indicating whether the portion of the telephone number is valid at the location to enable the client device to perform an action pertaining to making a call at the location.

16. A method as described in claim 15, wherein the portion of the telephone number includes an area code without other portions of a telephone number.

17. A method as described in claim 15, wherein the query further includes the portion of the telephone number.

18. A method as described in claim 15, wherein the query response comprises the policy.

19. A method as described in claim 15, wherein the policy indicates that the portion of the telephone number is not valid at the location, and the query response indicates that the portion of the telephone number is not valid at the location.

20. A method as described in claim 15, wherein:
the policy indicates that the portion of the telephone number is not valid at the location;
the method further comprises locating, by the computing system, a telephone number that is valid at the location; and
the query response indicates that the portion of the telephone number is not valid at the location and includes a telephone number that is valid at the location.
